(19) United States
(12) Patent Application Publication
(10) Pub. No.: US 2004/0126742 A1
(43) Pub. Date: Jul. 1, 2004

(54) Rubber dam punches used to prepare rubber dam membranes for general field isolation in dentistry

(76) Inventor: John Heasley, Iowa City, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/334,943

(22) Filed: Dec. 31, 2002

(51) Int. Cl. A61C 3/14

(52) U.S. Cl. 433/159; 433/141

(57) ABSTRACT

The invention describes rubber dam punches that punch the entire slit or central opening in a rubber dam membrane in order to prepare the conventional rubber dam for the slit-dam technique. The invention further describes rubber dam punches capable of lengthening the central opening in a rubber dam that is specifically designed for general field isolation. The rubber dam punches of the invention include a series of embodiments having upper and lower arm members, each arm member further having a gripping handle at one end of the arm member and an operative end extension at the opposite end of the arm member. The arm members are pivotally connected and have male and female slits dies attached to the operative end extensions which are used punch slits and/or holes of varying widths in dental rubber dam membranes in order to create or lengthen existing central openings in general field isolation rubber dams.

### BACKGROUND OF THE INVENTION

1. Field of the Invention

This invention relates to rubber dam punches used to prepare rubber dam membranes for use in dentistry, and more particularly the invention relates to rubber dam punches used to prepare rubber dam membranes used in general field isolation in dentistry and alternatively in medical specialty procedures.

2. Background

Rubber dam punches are commonly known in the dental prior art as devices used to punch small holes, generally in the range of 0.025″ to 0.100″, in rubber dams for the purpose of sequentially isolating individual teeth with the rubber dam membrane in what is commonly referred to as the conventional method of rubber dam isolation. The small round perforations that the rubber dam punch provides in the rubber dam allows the elastic rubber dam membrane to be stretched over individual teeth in such a manner that the clinical crowns of the teeth protrude from one side of the membrane where an operative procedure is to be performed. The end result is that a dentist may isolate the clinical crowns of the teeth in order to perform dental procedures necessary to treat dental diseases such as the removal of dental caries, which very often appears as a white chalky area on the enamel and later softens the enamel before the tooth structure breaks down.

Until recently, the conventional application of the rubber dam to isolate the clinical crowns of teeth, the crown being the visible portion of the tooth above the gum line, has been used exclusively in dentistry. Recently, however, new techniques and methods have evolved to isolate not only the clinical crowns of teeth, but also the gingival soft tissues. A technique, called the slit-dam technique, has evolved in which a dentist punches two holes located a required distance apart, and then cuts between the holes with a scissors to form a slit. This technique allows the dentist to stretch the rubber dam between a front and back tooth, thus isolating a series of teeth at a single time, rather than isolating each tooth individually. This slit-dam technique, while serving to quickly apply the rubber dam to a given segment of teeth, is generally inadequate in isolating the soft tissues simultaneously with the clinical crowns, due to the elastic rubber snapping back to the level of the gum line upon application. Further this technique of making a ‘make-shift’ slit in the dam with a pair of scissors has demonstrated a need for the preparation of alternative forms of perforations.

More recently, general field isolation rubber dams have been introduced to overcome the inherent limitations in the slit-dam technique in being able to isolate both the clinical crowns of the teeth and their associated soft tissues simultaneously. General field isolation rubber dams have prepared central openings that are slits of varying widths in order to be able to quickly isolate groups of teeth simultaneously. In some cases, general field isolation rubber dams are supplied without central openings so that a clinician may prepare both holes and slits in the dams in order to customize an application. In addition, some general field isolation rubber dams are available which have slits already prepared, but may require the slits to be lengthened by the clinician in order to customize an application. The invention of rubber dam punches which: perforate a rubber dam with openings such as slits, slots, elongated ovals, and elongated rectangular openings is needed to keep pace with the evolving art of practice of clinical isolation of the operative site in dentistry with general field isolation rubber dams. In addition, it is sometimes required by the clinician that either holes or alternatively slits be prepared in a rubber dam in succession, such that a hybrid application of the rubber dam be accomplished.

The prior art of rubber dam punches used in dentistry consists exclusively of punches that are capable of punching small holes, usually in the range of 0.025″ to 0.100′ in diameter for conventional isolation of the clinical crowns of individual teeth only. There are not any references in the prior art literature that refer to rubber dam punches that punch slits, slots, or other configurations of perforations for general field isolation in dentistry. In addition, there is no mention of any similar rubber dam punch in the prior art literature for punching perforations of any configuration for alternative medical uses in other medical specialties. Therefore, a need exists for a rubber dam punch capable of punching slits as well as hole perforations for use in the preparation of rubber dam membranes in general field isolation dentistry.

### SUMMARY OF THE INVENTION

The invention pertains to a series of embodiments of rubber dam punches having upper and lower arm members, each arm member further having a gripping handle at one end of the arm member and an operative end extension at the opposite end of the arm member. The arm members are pivotally connected and have male and female slits dies attached to the operative end extensions which are used punch slits of varying widths in dental rubber dam membranes in order to create or lengthen existing central openings in general field isolation rubber dams. The invention describes rubber dam punches that punch the entire slit or central opening in a rubber dam membrane in order to prepare the conventional rubber dam for the slit-dam technique. The invention further describes rubber dam punches capable of lengthening the central opening in a rubber dam that is specifically designed for general field isolation. In addition, the disclosure describes embodiments that may punch more than one configuration of perforation in the rubber dams, such as, but not limited to, both holes, and slits in the same instrument.

These and other objects of the present invention will become apparent to those skilled in the art upon reference to the following specification, drawings, and claims.

### BRIEF DESCRIPTION OF THE DRAWINGS

FIG. 1 is a top view of a rubber dam punch, showing the gripping handles and the cutting table which houses the female die elements.

FIG. 2 is a side view of a rubber dam punch showing the gripping handles from the side, and a side view of the male slit die engaging the cutting table.

FIG. 3 is an end view of the rubber dam punch showing the male slit die engaging the cutting table.

FIG. 4 is the male slit die from an end view, a bottom view, and an isometric view.

FIG. 5 is a top view of the cutting table, showing four variable width female slit dies machined into the cutting table.

FIG. 6 is an isometric view of a rubber dam punch designed to exclusively punch slits in rubber dams.

FIG. 7 is a top view of a rubber dam punch designed to punch both slits and holes in a rubber dam, showing the gripping handles from the top, and also the cutting table which houses both the female slit dies and the female hole dies.

FIG. 8 is a side view of a rubber dam punch designed to punch either slits or holes in a rubber dam, showing the gripping handles from the side and two male dies mounted on a pivoting carriage, and also the cutting table from a side view.

FIG. 9 is an end view of a rubber dam punch designed to punch either slits or holes in a rubber dam, showing a male slit die engaging the cutting table.

FIG. 10 is an isometric view and a bottom view of a male slit die.

FIG. 11 is an isometric view and a bottom view of a male hole die.

FIG. 12 is a top view of a cutting table machined with variable width female slit dies and variable width female hole dies.

FIG. 13 is an isometric view of a rubber dam punch designed to punch either holes, or slits in rubber dam membranes, with two male dies mounted to a pivoting carriage (above) and female slit dies and female hole dies machined into a pivoting cutting table (below).

FIG. 14 is a top view of a rubber dam punch designed with male and female slit dies on cylindrical carriages, showing one of the gripping handles and the upper male slit dies mounted on a pivoting cylindrical carriage.

FIG. 15 is a side view of a rubber dam punch designed with cylindrical carriages with male slit dies (above) articulating with female slit dies (below).

FIG. 16 is an end view of a rubber dam punch designed with cylindrical drums with male slit dies (above) articulating with female slit dies (below).

FIG. 17 is an illustration of a rubber dam punch being used to lengthen a slit in a field isolation rubber dam.

FIG. 18 is an isometric view of an alternative embodiment of a rubber dam punch using a male slit die on a cylindrical plunging mechanism and female slit dies machined into a cutting table to punch variable width slits in a rubber dam membrane.

FIG. 19 is an isometric view of a male slit die associated with the cylindrical plunging mechanism.

FIG. 20 is a top view of the cutting table with four variable width female slit dies as used with the cylindrical plunging mechanism.

FIG. 21 is an isometric view of an alternative embodiment of a rubber dam punch which punches a single width slit only, with a single male slit die and a single female slit die

### DETAILED DESCRIPTION OF THE INVENTION

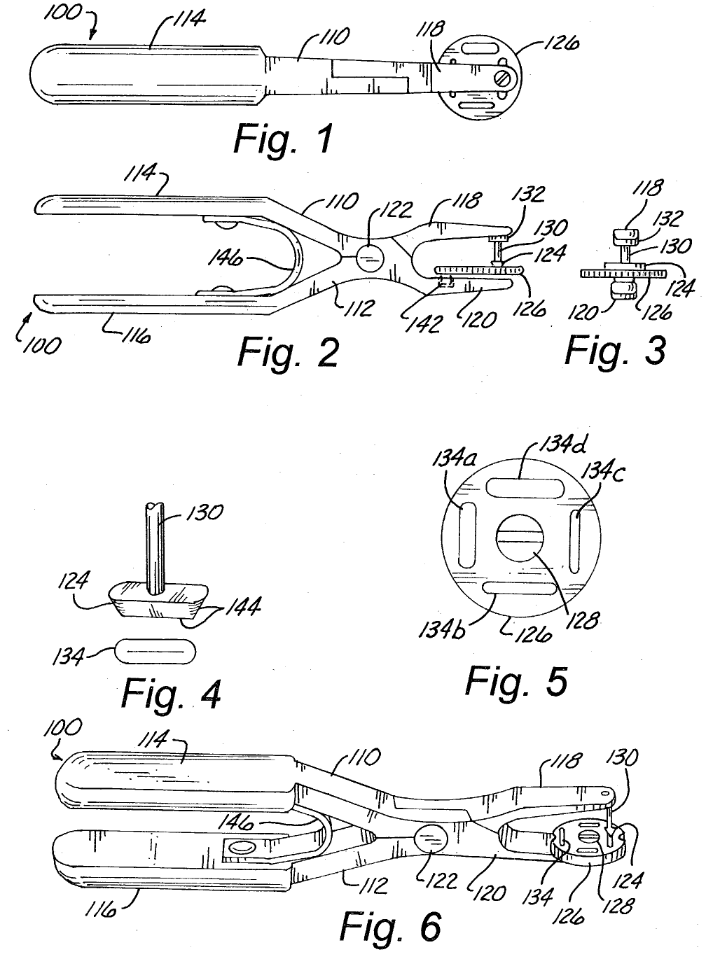

This invention pertains to a rubber dam punch 100, as seen generally in FIGS. 1-3 and 6 that is designed to punch slits of varying widths in a rubber dam membrane 50 (see FIG. 17). The rubber dam punch 100 is comprised of a pair of arms 110, 112, each arm including a gripping handle 114, 116 located at one end of the arms 110, 112 and an operable end extension 118, 120 located at the opposite end of the arms 110, 112. A pivoting center connector 122 is used to pivotally attaching the upper arm 110 to the lower arm 112. Seen in FIG. 2, on the operable end extension 118 of the lower arm 110, a male die mechanism 124 is mounted on the end opposite the pivoting center 122, and on the operable end extension 120, of the upper arm 112 a circular planar die mechanism called a cutting table 126, is mounted by a pivoting connector 128 on the corresponding end extension 120, radially from the pivoting center 122 of the arms 110, 112.

FIG. 4 shows the male die mechanism 124 mounted on a shaft 114, with a base 132 (see FIG. 3), that attaches to the upper operable end extension 118. FIG. 5 shows four variable width female slit dies 134a-134d machined into the cutting table 126, which has its own pivoting center 128. The pivotable cutting table 126 allows a dentist or clinician to rotate the cutting table 126 with finger pressure until one of the female slit dies 134a-134d is properly aligned with the male die 124. In FIG. 2, a locator pin 142 mounted in the lower operable end extension 120, engages a dimpled concave recess (not shown) in the bottom face of the cutting table 126, for the purpose of locking the cutting table 126 in proper position for the alignment of one of the female slit dies 134a-134d. The male slit die 124, is reciprocally mounted with respect to the location of the female slit dies 134a-134d, such that the male die 124 predictably inserts into one of the properly aligned female dies 134a-134d when the cutting table 126 is locked into proper position by the positioning pin 142.

### EXAMPLE 1

As seen in FIG. 17, when a rubber dam membrane 50 is interposed between the complementary male die 124 and any one of the single female slit dies 134a-1 34d of the cutting table 126, and the male 124 and female 134a-134d complementary dies are subsequently brought together by leveraged hand pressure applied to the gripping handles 114, 116, a perforation is made in the rubber dam membrane 50 in the shape of the corresponding female slit dies 134a-134d. The rubber dam punch 100 may also be used to lengthen a slit in the rubber dam membrane 50 in the same way it forms a perforation (discussed above). In this embodiment, the male slit die mechanism 124 is rigidly fixed in position on the upper operable end extension 118 of the lower arm 112 of the punch, while the female slit die mechanisms 134a-134d are located on the cutting table 126 and are capable of pivoting with the movements of the cutting table 126.

FIG. 4 shows male die slit element 124 as a wedge shaped structure with cutting surfaces 144 positioned at an acute angle with respect to the reciprocating planar surface of the cutting table 126 and also at an acute angle with the long axis of the male die's mounting shaft 130. Since the male die 124 has this configuration, its cutting surfaces 144 contact different width female die slits 134a-134d at a different position, thus maintaining a variable but complementary relationship with the alternative width female die slits 134a-134d. This configuration of a stationary male die 124 with angular cutting surfaces 144 and variable width female dies 134a-134d mounted on a pivoting cutting table 126 allows a variety of different width slits to be cut in a rubber dam 50. The type of slit in this application may be a linear slit, a curved slit, a slot, an elongated oval, or other configuration for dental applications or alternative forms utilizing the same basic principles of design for alternative medical use. Variations in the shapes and forms of dies for alternative uses should be considered to be fully within the spirit and scope of this disclosure. A resilient mounted opening spring 146 may be mounted between the gripping handles 114, 116 (seen in FIGS. 2 and 6) and used to maintain the rubber dam punch 100 in an open position between operations. The mounted opening spring 146 may alternatively be mounted between the operable end extensions, 118, 120.

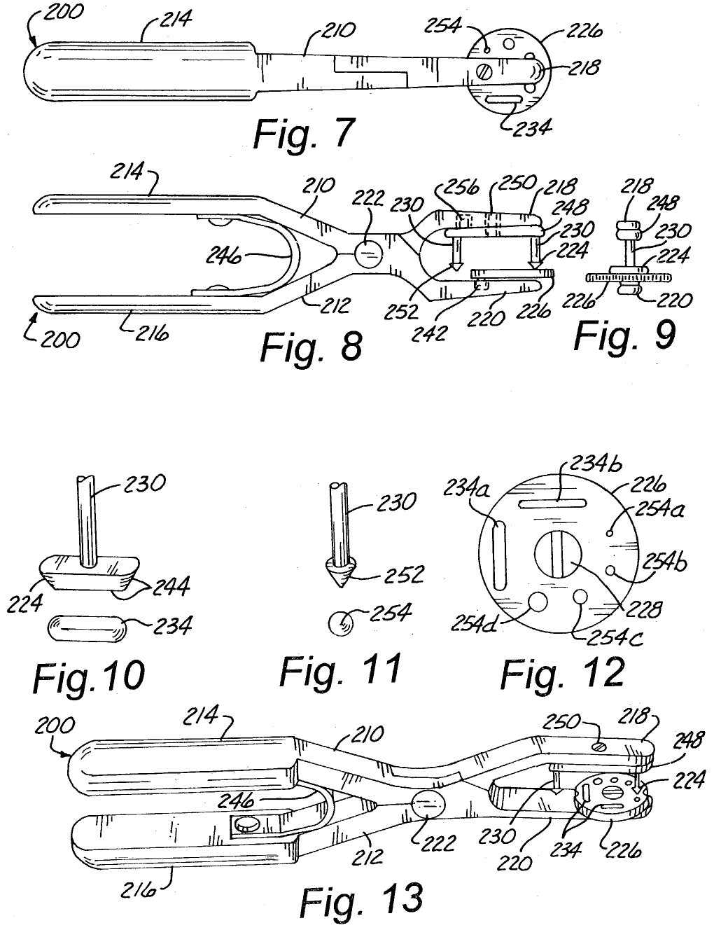

As seen in FIGS. 7-9 and 13, an alternative rubber dam punch 200, used to punch both holes and slits in a hybrid design. The punch features a pivoting mounting carriage 248 connected to the operable end extension 218 of the lower arm 210 by means of a pivoting connector 220. Two male die elements 224 and 252 are mounted on the ends of the pivoting mounting connector 250, as shown in the side view, seen in FIG. 8. These include a male slit die 224, with its mounting shaft 230, mounted on one end, while a male hole die 224, with its mounting shaft 230 mounted on the other end of the pivoting carriage 248. In this embodiment of a rubber dam punch 200, configured with both a male slit die 224 and a male hole die 252, which pivots 180 degrees on the pivotable mounting carriage 248 such that either die 224 or 252 may be selectively positioned opposite the reciprocating cutting table 226, which houses two female slit dies 234a and 234b and also has four female holes dies 254a-254d, as illustrated in FIG. 12. The mounting carriage 248 which houses the two types of male dies 224 and 252 and pivots 180 degrees with finger pressure, to position either of the two male dies 224 and 252 opposite a reciprocal female die 234 or 254 has two dimpled recesses on the surface (not shown) contacting the operative end extension 218, to which it is mounted, such that a positioning pin 256, may engage said dimples, in order to predictably position a selected male die 224 or 252 in the precise position in order to engage its complementary female die 234 or 254. FIG. 8 shows that on the planar surface of the mounting carriage 248 facing the operable arm extension 218 to which it is mounted, is a concave dimpled depression (not shown) which receives a positioning pin 256, mounted within the operable arm extension 218 which locks the pivotable mounting carriage 248 in position such that the male die 224 or 252 is properly positioned opposite a corresponding female die 234 or 254 on the opposing arm extension 220, when the pivotable mounting carriage 248 is locked in alignment. On the opposing arm extension 220 is mounted a cutting table 226 which has both female slit dies 234a and 234b and female hole dies 254a-254d machined into positions for articulation with the appropriate male dies 224 and 252 respectively.

When a male die 252 for punching holes is aligned with any one of the reciprocating female hole dies 254a-254d and the corresponding male 252 and female dies 254a-254d are brought together under pressure with a rubber dam membrane 50 interposed between the dies 252 and 254, as in FIG. 17, a circular hole perforation is made in the elastic membrane of a rubber dam 50 corresponding to the form and size of the dies 252 and 254 aligned at the time of perforation. When a male slit die 224 is brought into alignment with either one of the two female slit dies 234a or 234b with a rubber dam membrane 50 interposed between the complementary dies 224 and 234, a slit perforation is made in the rubber dam membrane 50. Thus this embodiment allows for the punching of either holes or slits by one instrument, and allows a dentist the option of quickly changing the form of perforation required for a given application of the rubber dam 50. This alternative configuration may be expanded to more than two male dies 224 and 252 mounted on a pivotal carriage 248 and may be varied according to the form of perforation required for alternative uses of preparation of rubber dams 50 in medical applications in specialty areas other than dentistry. The configuration described above is illustrative of the principles of the basic design elements comprising the elements of the invention only. Obvious alterations of design may occur to individuals skilled in the art, which, while being somewhat different from the aforementioned design and equally efficacious, would be considered to be fully within the spirit and scope of this disclosure.

### EXAMPLE 2

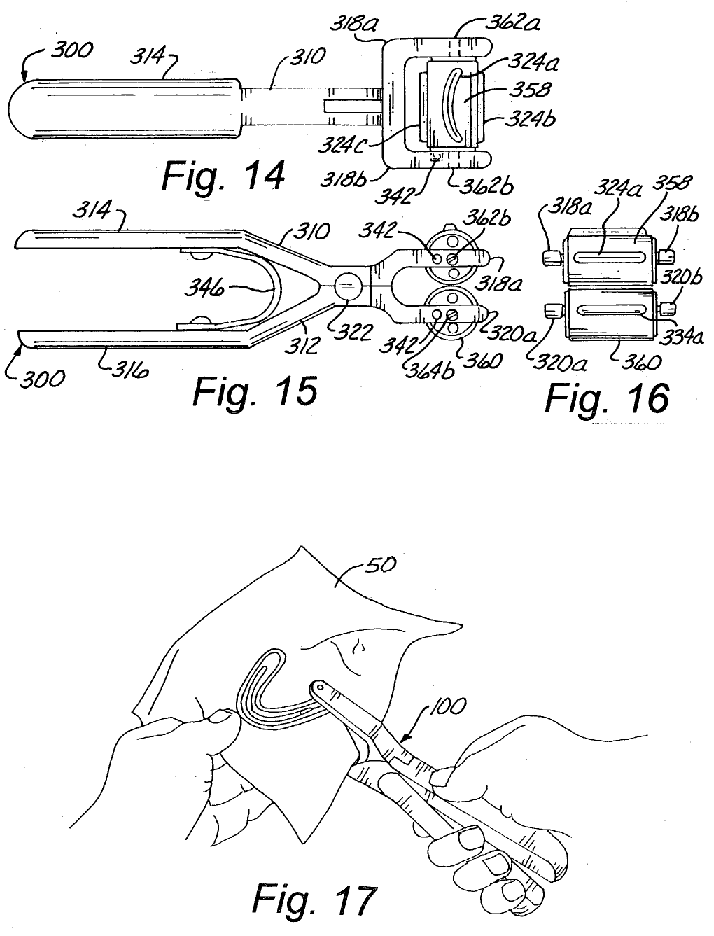

FIGS. 14, 15, and 16 depict another alternative rubber dam punch 300 which punches long slits in rubber dam membranes 50, with male slit dies 324a-324d mounted on an upper cylindrical drum 358 and female slit dies 334a-334d, the 334a-334d female slit dies are arranged at 90 degree separation from one another (not shown), mounted on a lower cylindrical drum 360. This rubber dam punch 300 has an upper arm member 310 and a lower arm member 312, each with their respective gripping handles 314, 316 and each with their respective operative end extensions 320, 318. As shown in FIG. 14, the operative end extensions 318, 320 bifurcate into a square “U” configuration. Thus end extension 318 bifurcates into two leg extensions 318a and 318b, while the end extension 320 bifurcates into two leg extensions 320a and 320b. Each of the leg extensions, 318a and 318b has upper pivoting connectors 362a and 362b, for the attachment of the cylindrical drum 358, housing the male slit dies 324a-324d. The leg extensions 320a and 320b also have lower pivoting connectors 364a and 364b for attachment of the lower cylindrical drum 360, housing the female slit dies 334a-334d. The female dies 334a-334d and the male dies 324a-324d are sequentially mounted at 90 degree intervals on their respective pivoting cylindrical drums 360 and 358, with a locator pin mechanism 342 located in the arm extensions 318a and 320a respectively, to engage dimpled concave recesses (not shown) on each of the cylindrical drums 358 and 360 to lock the cylindrical drum(s) 358 and 360 in place when they are in a properly aligned correct position.

When complementary male 324a-324d and female die elements 334a-334d are in proper position, and brought together under pressure with a rubber dam membrane 50 interposed between the die elements 324a-324d and 334a-334d, a perforation is made in the configuration of the die elements 324a-324d and 334a-334d. The cylindrical mounting drums 358 and 360 may be mounted with their axes in alternative configurations with respect to the long axis of the extension arms 318 and 320 upon which they are mounted and still be within the spirit and scope of this disclosure.

### EXAMPLE 3

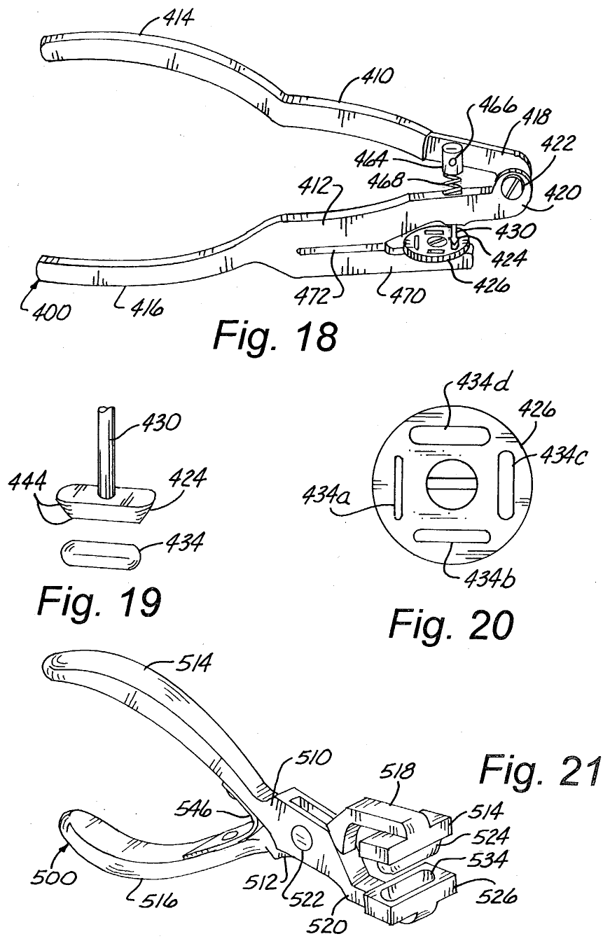

FIG. 18 is an isometric view of a third alternative embodiment of a rubber dam punch 400, which has a male slit die 424 connected to a cylindrical plunging mechanism 464 by means of a mounting shaft 430. This embodiment has an upper arm member 410, and a lower arm member 412, pivotally connected to each other at their operable ends 418, 420, by means of a pivoting connector 422. Both the upper arm member 410 and the lower arm member 412, have gripping handles 414, 416 respectively. Pivotally connected to the upper arm member 410 is an intervening compensating connector 466, which pivotally connects to a cylindrical plunging mechanism (not shown) with a male slit die 424, connected to the other end of the cylindrical plunging mechanism by means of a shaft 430. A compressible spring 468 is mounted on the cylindrical plunging mechanism and interposed between the intervening compensating connector 466, and the operable end 420, of the lower arm member 412.

FIG. 18 shows that pivotally mounted on a projection 470, of the lower arm member 412, and opposite a slotted recess 472, is a cutting table 426, which has variable width female die slits 434a-434d machined into the cutting table 426. A detailed illustration of the cutting table 426 with the four variable female slit dies 434a-434d is seen in FIG. 20. Due to the location of the cylindrical plunging mechanism (not shown) substantially near the pivoting connector 422, pressure applied to the gripping handles 414, 416 of the upper and lower arms 410, 412, is leveraged, such that the male slit die 424, forcibly engages a reciprocating female slit die 434a-434d when it is in proper alignment. The cutting table 26 pivots such that variable width female slit dies 434a-434d may be individually selected to punch variable width slits in a rubber dam membrane 50. The cutting table 426, has a dimpled recesses on the surface (not shown) which contacts the projection 470, to which it is attached, receives a positioning pin 442 located within the projection 470, which predictably aligns the selected female slit die 434a-434d in position for receiving the male slit die 424 when in use.

### EXAMPLE 4

FIG. 21 depicts a fourth embodiment of the rubber dam punch 500 capable of creating a single width slit. This embodiment has an upper arm member 510 and a lower arm member 512, connected to each other with a pivoting connector 522. The upper arm 510 has a gripping handle 514 and an operative end extension 520, to which is connected a transverse mounting plate 526, with a single female slit die 534 machined into it. The lower arm member 512 has a gripping handle 516 on one end, and an operative end extension 518, on its opposite end. Connected to the operative end extension 518 of the lower arm member 512 is a transverse mounting plate 574 with a single male slit die 524 attached. A spring mechanism 546 is attached to both the upper 510 and lower arm members 512, such that the spring mechanism 546 maintains the rubber dam punch 500 in an open position when not in use. When reciprocal pressure is applied to the gripping handles 514, 516 the upper and lower arm members 510, 512, pivot about the pivoting center 522, causing the male slit die 524 and the female slit die 534 to come together. If a rubber dam membrane 50 is interposed between the two complementary dies 524 and 534 and enough pressure is applied, a perforation in the form of a slit is made in the rubber dam membrane 50.

With respect to the above described embodiments, it is to be realized that the general configurations and embodiments of the invention are illustrative of the function and the manner of operation of said invention, and the assembly and use of said invention should be readily apparent to one skilled in the art of dentistry. Equivalent relationships to those illustrated in the drawings and described in the specifications expressing variations in size, materials, shape, form, function, and manner of operation, but which describe equivalent relationships to those illustrated in this disclosure are to be considered to be within the spirit and scope of the invention. Further, since numerous modifications and changes will readily occur to those skilled in the art, it is not desired to limit the invention to the exact construction and operation shown and described, and accordingly, all suitable modifications and equivalents falling within the spirit and scope of the invention may be resorted to by the inventor. By way of example, the preferred material composition of the inventions described is stainless steel, and in the case of the cutting components, a tempered tool steel or hardened stainless steel. Alternatively, other metals could be used, and conceivably, the use of space-age plastics or composites might be substituted in some or all parts to decrease the overall cost of manufacturing the instruments. Regardless of the substitution of materials, the resulting rubber dam punches would fall within the spirit and scope of this disclosure. By way of another example, parts and components of the different alternative embodiments could be combined into a hybrid instrument, such as a single long male slit die 124, of instrument 100, manufactured into the configuration of instrument 300, with a reciprocal cylindrical drum 360, into which variable width female slit dies 334a-334d are machined. This would produce a rubber dam punch 100, which punches long slits in a rubber dam membrane 50, which is a hybrid of the embodiments described in this disclosure, but still fall within the spirit and scope of this disclosure. The embodiment described as instrument 200, which punches both circular hole perforations and also slits, could be designed to punch alternative configurations of perforations, such as squares and rectangular openings, just to cite an example. This same configuration could be configured to punch more than two alternatives; three, four, etc. Another example of an alternative embodiment would be the design of a rubber dam punch which punches quite large perforations of triangular, square, rectangular, pentagonal, heptagonal, septagonal, octagonal, or circular configuration for isolation of intestinal segments during anastomosis in abdominal surgery.

Further, the use of rubber dams in gastroenterology for the purpose of isolating intestinal segments to prevent the dissemination of microorganisms in the peritoneal cavity, thus decreasing the post-operative risk of peritonitis, is an excellent example of a specific application of rubber dams and the need for rubber dam punches in medicine. Other medical applications include vascular surgery during grafting procedures. The use of rubber dam in order to isolate the cut ends of the vas deferens during vasectomy has been reported in the medical literature. Since rubber dam punches have never been specifically designed for medical surgical purposes, the range of configuration of rubber dam punches to be designed for medical purposes within the spirit and scope of this disclosure is quite broad.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

I claim:

1. A rubber dam punch for perforating a rubber dam membrane used in general field isolation of an operative site, the rubber dam punch comprising:
a. an upper arm member and a lower arm member, the upper and lowers arms connected by a pivoting connector;
b. the upper arm member and lower arm members having gripping handles on one end of the arms;
c. the arms further comprising an upper and lower operative end extension, the extensions being opposite the ends of the arms having the gripping handles; and
d. the upper operative end extension having a male die and the lower operative end extension having a female die, the female and male dies brought together by pressure applied to the gripping handles, in order to make a perforation in a rubber dam membrane.

2. The rubber dam punch as defined in claim 1, wherein the male and female dies are slit dies and the punch produces a slit in the rubber dam membrane in order to prepare the rubber dam membrane for general field isolation in dentistry.

3. The rubber dam punch as defined in claim 1, wherein the male and female dies are hole dies and the punch produces as hole in the rubber dam membrane in order to prepare the rubber dam membrane for general field isolation in dentistry.

4. The rubber dam punch as defined in claim 1, wherein the arms of the punch further comprising:
a. the upper operative end extension member having a mounted stationary male die mechanism;
b. the lower operative end extension member having a mounted female die mechanism;
c. a pivoting anvil connecting the female slit die mechanism to the operable end extension having multiple variable widths, thus allowing for variable alignment of individual female slit dies of the mechanism;
d. a means for direct alignment of the male and female slit dies such that slit perforations of variable widths may be made in the rubber dam membrane; and
e. a locating mechanism ensuring the alignment of the male and female slit dies of the cylindrical drums.

5. The rubber dam punch as defined in claim 4, wherein the punch produces either holes or slits in the rubber dam membrane in order to prepare rubber dam membrane for either conventional isolation or general field isolation or a hybrid type of isolation in dentistry

6. The rubber dam punch as defined in claim 5, wherein the punch further comprises:
a. the upper operative end extension of the arm member mounted to a pivoting male die mechanism;
b. the pivoting male die mechanism having a male slit die mounted on one side of the mechanism and a male hole die mechanism mounted on the other side of the pivoting mechanism;
c. the lower operative end on the second arm member mounted to a pivoting female die mechanism;
d. the pivoting female die mechanism further comprised of female slit dies having variable widths and female hole dies of variable diameters;
e. a means for variable alignment of both the female dies and the male dies such that either variable diameter hole perforations or variable width slit perforations may be made in the rubber dam membrane; and
f. a locating mechanism ensuring the alignment of the male and female slit dies of the cylindrical drums.

7. The rubber dam punch as defined in claim 2, wherein the slits made in the rubber dam membrane may be of either a straight or curved configuration.

8. A rubber dam punch used for creating perforations in a rubber dam membrane in dentistry or other medical specialty areas, comprising:
a. an upper arm member joined to a lower arm member by means of a pivoting connector at a location near its center, the upper arm having a gripping handle at one end of the upper arm member and an operable end extension at the opposite end of the upper arm member, the lower arm member having a gripping handle at one end of the lower arm member and an operable end extension at the opposite end of the lower arm;
b. the pivoting connector connecting the upper and lower arm members together in a manner in which allow the arms to pivot with respect to one another;
c. a pivoting cylindrical drum having multiple variable width male slit dies radially located on the cylindrical drum, the cylindrical drum attached to the operable end extension of the upper arm member;
d. a pivoting cylindrical drum having multiple variable width female slit dies radially located on the cylindrical drum, the cylindrical drum attached to the operable end extension of the lower arm member;
e. a means for pivotally aligning the male slit die with the corresponding female slit die by rotating the upper and lower cylindrical drums until alignment of the male and female dies is achieved;
f. a locating mechanism ensuring the alignment of the male and female slit dies of the cylindrical drums; and
g. a means for applying leveraged pressure to the upper and lower arm members for the to bring the male and female slit dies together with pressure in order to punch a perforation in the rubber dam membrane.

9. The rubber dam punch as defined claim 1, wherein the punch further comprises:
a. a means for connecting a punching mechanism which is a plunging cylindrical piston device located between the gripping handles and attached pivoting end, the location being substantially nearer to the operable end extension of the cylindrical shaft allowing the plunging cylindrical punching mechanism to slide through the cylindrical shaft;
b. the male slit die being attached to the cylindrical shaft, the cylindrical shaft which movably slides through a cylindrical guide machined in the lower arm, and is variably attached at the end opposite the male slit die to the pivoting upper arm member,
c. a means for forcibly applying leveraged pressure to the punching mechanism by hand pressure applied to the gripping handles to predictably move the punching mechanism through the cylindrical guide to force the male slit die into the reciprocal female slit die machined into a pivoting cutting table,
d. the pivoting cutting table having the number of variable width female slit dies machined into the cutting table radially of its pivoting center, and a means for rotating the circular planar anvil about its pivoting center to select individual variations of widths of female slit dies to oppose a male slit die mechanism,
e. a dimpled recess on the side of the planar anvil facing the lower arm member to which it is mounted which receives a spring loaded locator pin assembly which predictably positions individual female slit dies in a reciprocal position to an opposing male slit die.

10. The rubber dam punch of claim 1 which punches a single width slit in the rubber dam membrane to prepare it for general field isolation, comprising:
a. a single female slit die attached to a transverse mounting plate located on the operative end extension of the upper arm member;
b. a single male slit die attached to a transverse mounting plate located on the operative end extension of the lower arm member; and
c. a means of applying pressure to the gripping handles in order to bring the female slit die and the male slit die together in order to make a perforation in the rubber dam membrane.

11. The rubber dam punch as defined in claim 1, wherein the design of a generally elongated pyramidal form of male slit die interacts with variable width female slit dies to form variable width slit perforations in the rubber dam membrane

12. The rubber dam punch as defined in claim 1, wherein the punch may be configured to punch a variety of alternative configurations of perforations in rubber dams for medical procedures.

13. A method of preparing a rubber dam for use in general field isolation, comprising the step of punching a single perforation in the rubber dam to create an opening through which the entire field is exposed.

14. The method of claim 13, wherein the field is a portion of the dental alveolar arch.

15. A method of enlarging the pre-formed opening in a rubber dam used for general field isolation, comprising the step of using the punch of claim 1 to enlarge the pre-formed opening to conform the rubber dam to the field being isolated.
